(19) United States
(12) Patent Application Publication
(10) Pub. No.: US 2025/0317577 A1
(43) Pub. Date: Oct. 9, 2025

(54) PURPOSE BUILT VEHICLE FOR TRANSMITTING VIDEO DATA AND OPERATION METHOD THEREOF

(71) Applicant: Seoul Dynamics, Gyeonggi-do (KR)

(72) Inventors: Geosong Lee, Gyeonggi-do (KR); Yongseung Lee, Gyeonggi-do (KR); Seunghan Chung, Gyeonggi-do (KR)

(21) Appl. No.: 19/007,204

(22) Filed: Dec. 31, 2024

(30) Foreign Application Priority Data
Apr. 9, 2024 (KR) 10-2024-0047943

(51) Int. Cl. H04N 19/167; H04N 19/119; H04N 19/156; H04N 19/17

(52) U.S. Cl. CPC H04N 19/167; H04N 19/119; H04N 19/156; H04N 19/17

(57) ABSTRACT

A purpose-built vehicle device includes a driving unit, a camera, a communication unit, and at least one processor connected to the driving unit, the sensor unit, and the communication unit. The at least one processor acquires a driving image of the PBV through the camera, divides the entire region of the driving image into one or more sub-regions based on at least one of the vehicle's network status, the vehicle's location information, or the vehicle's resource usage rate, determines a pre-processing option for the one or more sub-regions, and encodes the one or more sub-regions of the driving image based on the pre-processing option to obtain one or more pieces of encoded data. The pre-processing option can include resolution and bitrate.

### CROSS-REFERENCE TO RELATED APPLICATIONS

The present application claims under 35 U.S.C. § 119(a) the benefit of Korean Patent Application Number 10-2024-0047943 filed Apr. 9, 2024, the entire contents of which application is incorporated herein for all purposes by this reference.

### TECHNICAL FIELD

The embodiments disclosed in this disclosure relate to a purpose-built vehicle for image decoding and a method of operating the same.

### BACKGROUND

A purpose-built vehicle (PBV) is a mobility device designed or manufactured for a special purpose and refers to a means of transportation that travels based on autonomous driving and remote driving. Depending on its purpose, a PBV can be optimized to perform specialized tasks or functions, and can be used in various fields such as transportation, logistics delivery, construction, ports, etc. A PBV needs to adapt to a variety of environments and situations; for this, the vehicle can collect and analyze various data and carry out learning.

### SUMMARY

A purpose-built vehicle (PBV) can be controlled remotely from a control device, in addition to autonomous driving. In order to be controlled remotely from the control device, a PBV can transmit images of its operation to the control device.

Based on the above discussion, the present disclosure provides a device and method for a purpose-built vehicle to transmit video data to a control device while minimizing latency.

According to one embodiment of the present disclosure, a purpose-built vehicle device includes a driving unit, a camera, a communication unit, and at least one processor connected to the driving unit, the sensor unit, and the communication unit. The at least one processor:
acquires a driving image of the purpose-built vehicle through the camera;
based on at least one of the vehicle's network statuses, the vehicle's location information, or the vehicle's resource usage rate, divides the entire region of the driving image into one or more sub-regions;
determines a pre-processing option for the one or more sub-regions; and.
encodes the one or more sub-regions of the driving image based on the pre-processing option to acquire one or more pieces of encoded data, where the pre-processing option can include resolution and bitrate.

In some embodiments, the at least one processor can transmit image data including the one or more pieces of encoded data to the control device through the communication unit.

In some embodiments, the at least one processor, through the driving unit, can identify the steering state and driving state of the purpose-built vehicle, and can identify the one or more sub-regions based on the steering state and the driving state.

In some embodiments, the at least one processor can be configured to determine the weighting of the one or more sub-regions based on the steering state and the driving state, and to determine the resolution and bitrate of the one or more sub-regions based on that weighting.

In some embodiments, the at least one processor can be configured to perform the encoding for sub-regions among the one or more sub-regions that have a weight above a threshold.

In some embodiments, the at least one processor can identify the battery status of the purpose-built vehicle and, if the battery status is below a predetermined value, can be configured to perform the encoding only on the region with the largest weight among the one or more sub-regions.

In some embodiments, if the purpose-built vehicle is located in a predetermined area and the vehicle's speed is identified to be below a threshold speed, the at least one processor can be configured to perform the encoding on the entire region of the driving image.

In some embodiments, among the one or more sub-regions, the at least one processor can be configured to determine the weight of the sub-region located in the direction corresponding to the steering state to be higher than the weight of the region corresponding to the opposite direction of that steering state.

In some embodiments, upon identifying a predetermined type of object in the driving image, the at least one processor can be configured to set the resolution and bitrate of the region containing that object higher than the resolution and bitrate of the region not containing that object.

According to one embodiment of the present disclosure, a method of operating a purpose-built vehicle device includes:
acquiring a driving image of the purpose-built vehicle via a camera;
dividing the entire region of the driving image into one or more sub-regions based on at least one of the vehicle's network status, location information, or resource usage rate;
determining a pre-processing option for the one or more sub-regions; and.
encoding the one or more sub-regions of the driving image based on the pre-processing option one or more pieces of encoded data, to acquire where the pre-processing option may include resolution and bitrate.

In some embodiments, the operating method of the purpose-built vehicle can further include transmitting image data that includes the one or more pieces of encoded data to the control device via the communication unit.

In some embodiments, the operating method of the purpose-built vehicle can include operations to identify the steering state and driving state of the vehicle (through the driving unit), and to identify the one or more sub-regions based on the steering state and the driving state.

In some embodiments, the operating method can include determining the weighting of the one or more sub-regions based on the steering state and the driving state, and determining resolution and bitrate of the one or more sub-regions based on that weighting.

In some embodiments, the operating method can include performing the encoding for sub-regions among the one or more sub-regions that have a weight above a threshold.

In some embodiments, the operating method can include: identifying the battery status of the purpose-built vehicle, and if the battery status is below a predetermined value, performing the encoding only for the region that has the largest weight among the one or more sub-regions.

In some embodiments, the operating method can include, if it is identified that the purpose-built vehicle is located in a predetermined area and that the vehicle's speed is below a threshold speed, performing the encoding on the entire region of the driving image.

In some embodiments, a purpose-built vehicle device comprises a driving unit, a camera, a communication unit, and at least one processor connected to the driving unit, a sensor unit, and the communication unit, wherein the at least one processor acquires, through the camera, a driving image of the purpose-built vehicle; divides the entire region of the driving image into one or more sub-regions based on at least one of the vehicle's network status, location information, or resource usage rate; determines a pre-processing option for the one or more sub-regions; and encodes the one or more sub-regions of the driving image based on the pre-processing option to obtain one or more pieces of encoded data, wherein the pre-processing option includes a data selection ratio, resolution, and bitrate, and wherein the at least one processor is configured to perform image windowing in order to select only some sub-regions (one or more) of the original image (ISP input size) and encode only those regions. The at least one processor may be configured to define a specific region of interest (ROI) within the entire original image region (ISP input size), extract only the pixel data corresponding to the selected one or more sub-regions from the original driving image, and encode the extracted data. An offset (X_OFFSET, Y_OFFSET) may be defined as the distance from the start point of the original image to the start point of the selected region, and the offset is set variably in consideration of the network status, resource load rate, or location information. A pre-scaling size may indicate the size of the selected image region before resizing, and a data output size indicates the size of the output after scaling.

Embodiments of the present disclosure provide an effect of minimizing latency between a purpose-built vehicle and a control device.

Also, there is an effect that makes it possible to adaptively determine how to encode the video data depending on the network status and operating conditions of the purpose-built vehicle.

The effects achievable by the present disclosure are not limited to the effects mentioned in the various embodiments, and other non-mentioned effects will be clearly understood by those skilled in the art from the descriptions below.

### BRIEF DESCRIPTION OF THE DRAWINGS

FIG. 1 illustrates an example of an operating environment for a purpose-built vehicle according to an embodiment.

FIG. 2 illustrates a block configuration of a purpose-built vehicle according to an embodiment.

FIG. 3 illustrates a block configuration of a base station according to an embodiment.

FIG. 4 illustrates a block configuration of a control device according to an embodiment.

FIG. 5 illustrates an example of a driving environment for a purpose-built vehicle according to an embodiment.

FIG. 6 illustrates another example of a driving environment for a purpose-built vehicle according to an embodiment.

FIG. 7 illustrates an operational flow of a purpose-built vehicle according to an embodiment.

FIG. 8 illustrates an example of image region partitioning for a purpose-built vehicle according to an embodiment.

FIG. 9 illustrates an example of per-region pixel selection in a purpose-built vehicle according to an embodiment.

FIG. 10 illustrates another example of per-region pixel selection in a purpose-built vehicle according to an embodiment.

FIG. 11 illustrates an example of image windowing according to an embodiment.

FIG. 12 illustrates an example of per-region encoding by a purpose-built vehicle according to an embodiment.

FIG. 13 illustrates another example of per-region encoding by a purpose-built vehicle according to an embodiment.

FIG. 14 illustrates an example of latency according to per-region encoding in an embodiment.

In connection with the description of the drawings, identical or similar components may use identical or similar reference numerals.

### DETAILED DESCRIPTION FOR SPECIFIC EMBODIMENTS

Below, with reference to the drawings, embodiments of the present disclosure will be described in detail so that those skilled in the art to which the present disclosure pertains can easily carry them out. However, the present disclosure can be implemented in a variety of different forms and is not limited to the embodiments described here. In the description of the drawings, identical or similar components may use identical or similar reference numerals. Also, in the drawings and the related description, details of well-known functions and configurations may be omitted for clarity and conciseness.

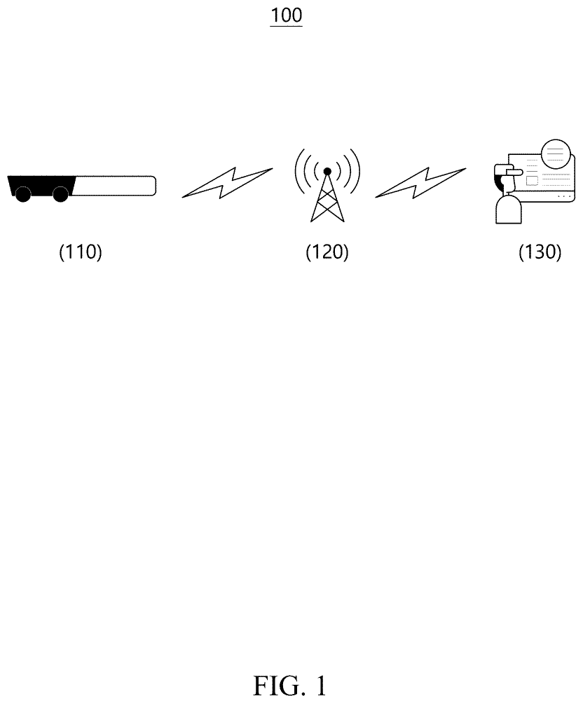

FIG. 1 illustrates an example of a driving environment for a purpose-built vehicle according to an embodiment. FIG. 1 shows, as part of the nodes that utilize a wireless channel in a driving environment, a purpose-built vehicle (110), a base station (120), and a control device (130). FIG. 1 shows only one base station, one purpose-built vehicle, and one control device, but there may be more devices identical or similar to the purpose-built vehicle (110), the base station (120), or the control device (130).

According to one embodiment, the driving environment (100) of a purpose-built vehicle can include a purpose-built vehicle (110), a base station (120), and a control device (130).

In some embodiments, the purpose-built vehicle (110) is a device capable of autonomous and remote driving by a user and can communicate with the base station (120) via a wireless channel. The purpose-built vehicle (110) can be operated without user involvement-that is, it can be a device that performs machine-type communication (MTC). The purpose-built vehicle (110) can be referred to as an autonomous driving device, remote driving device, or by other terms of equivalent technical meaning. The purpose-built vehicle (110) can be connected with various types of work modules to perform diverse functions.

In some embodiments, the base station (120) is a network infrastructure that provides wireless access to the purpose-built vehicle (110). The base station (120) has coverage defined as a certain geographic area based on the distance at which it can transmit a signal. In addition to being called a base station, the base station (120) may also be referred to by other terms of equivalent technical meaning such as “access point (AP),” “eNodeB (eNB),” “5G node,” “wireless point,” or “transmission/reception point (TRP).”

In some embodiments, the control device (130) can include a control apparatus for controlling the purpose-built vehicle (110). The control device (130) may be referred to as a “control device” or “control server.”

In some embodiments, the base station (120) and the purpose-built vehicle (110) can transmit and receive wireless signals in the millimeter-wave (mmWave) band (for example, 28 GHz, 30 GHz, 38 GHz, 60 GHz). In that case, to improve channel gain, the base station (120), the purpose-built vehicle (110), and the purpose-built vehicle (110) can perform beamforming (both transmit beamforming and receive beamforming). That is, the base station (120), the purpose-built vehicle (110), and the purpose-built vehicle (110) can impart directivity to transmit or receive signals. For this, the base station (120) and the purpose-built vehicle (110) can select serving beams (112, 113, 121, 131) through a beam search or beam management procedure. Once the serving beams (112, 113, 121, 131) are selected, subsequent communication can be performed via resources that have a quasi-co-located (QCL) relationship with the resources that transmitted the serving beams (112, 113, 121, 131).

In some embodiments, if the large-scale characteristics of the channel that delivered symbols on the first antenna port can be inferred from the channel that delivered symbols on the second antenna port, then the first antenna port and the second antenna port may be evaluated to be in a QCL relationship. For example, large-scale characteristics may include at least one of delay spread, doppler spread, doppler shift, average gain, average delay, or spatial receiver parameters.

In some embodiments, the purpose-built vehicle (110) can be controlled by a remote-control signal received from the control device (130). In the following description, even though the control device (130) receives data from or transmits data to the purpose-built vehicle (110), such data communication may be performed via the base station (120). In other words, the purpose-built vehicle (110) transmits data to the base station (120), and the base station (120) transmits data it received from the purpose-built vehicle (110) to the control device (130). The control device (130) transmits data to the base station (120), and the base station (120) transmits to the purpose-built vehicle (110) the data it received from the control device (130). Hereafter, “transmitting and receiving data between the control device (130) and the purpose-built vehicle (110)” can be understood to include communicating data via the base station (120).

In some embodiments, the purpose-built vehicle (110) can transmit to the control device (130) data related to its driving. Such data may include video data obtained through the camera of the purpose-built vehicle (110), information related to the speed of the vehicle, the steering state, etc.

In some embodiments, the control device (130) can receive driving-related video data of the purpose-built vehicle (110) from the purpose-built vehicle (110).

In some embodiments, the control device (130) can decode the video data received from the purpose-built vehicle (110) and display it via the control device's display.

In some embodiments, the control device (130) can transmit to the purpose-built vehicle (110) data required for the vehicle's driving. For example, the control device (130) can transmit data for remote driving to the purpose-built vehicle (110). For example, the control device (130) can transmit information about other purpose-built vehicles engaged in cooperative driving to the purpose-built vehicle (110). For example, the control device (130) can transmit operating information needed for the vehicle's driving (e.g., spec information of the purpose-built vehicle (110), spec information of the work module connected to the purpose-built vehicle (110), and information about the area where the vehicle is traveling) to the purpose-built vehicle (110).

In some embodiments, the control device (130) can receive from the purpose-built vehicle (110) the vehicle's driving-related data. For example, the control device (130) can receive from the purpose-built vehicle (110) the vehicle's driving data (e.g., driving time, speed, distance, path, environment, output, etc.). For example, the control device (130) can receive from the purpose-built vehicle (110) data the vehicle obtained from other vehicles (e.g., other PBVs in cooperative driving, or other vehicles on the road).

In some embodiments, the control device (130) can train a plurality of autonomous driving models required for driving the purpose-built vehicle (110) based on the driving-related data received from the vehicle (110). The multiple autonomous driving models can be plural in number, depending on the vehicle's environment and the type of connected work module, and the control device (130) can train each autonomous driving model.

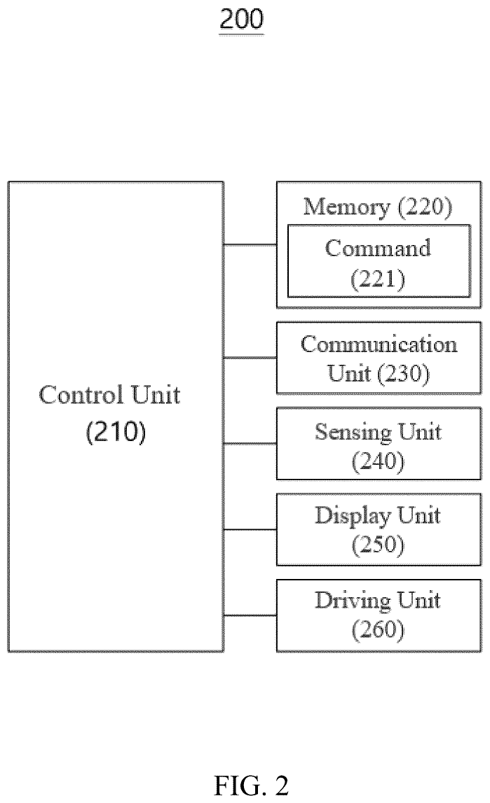

FIG. 2 illustrates a block configuration of a purpose-built vehicle according to an embodiment.

According to one embodiment, the purpose-built vehicle (110) can include a controller (210), memory (220), a communication unit (230), a sensing unit (240), and a driving unit (250).

In some embodiments, the memory (220) is a storage medium used by the purpose-built vehicle (110) and can store data such as at least one command (221) or setting information corresponding to at least one program. The program can include an operating system (OS) program and various application programs.

In some embodiments, the memory (220) can store data received from an external electronic device (for example, another purpose-built vehicle) located adjacent to the vehicle (110). For example, data received from an external electronic device can include information about a work module or information about the work environment.

In some embodiments, the memory (220) can include at least one type of storage medium such as a flash memory, a hard disk, a micro-type multimedia card, a card-type memory (e.g., SD optical disk.

In some embodiments, the communication unit (230) can provide a wired/wireless communication interface that enables communication with external devices (e.g., other vehicles, a control device, a relay device).

In some embodiments, the communication unit (230) can include at least one of a wireless LAN module or a short-range wireless communication module. The wireless LAN module may include Wi-Fi and can support the IEEE 802.11x standard of the IEEE (Institute of Electrical and Electronics Engineers).

In some embodiments, the communication unit (230), under the control of the controller (210), can connect wirelessly to an AP (Access Point). An AP in a computer network can be a device that connects devices using Wi-Fi or related standards. For example, the relay device (130) can perform the function of an AP.

In some embodiments, the communication unit (230), under the control of the controller (210), can perform short-range wireless communication with an external device. Such short-range communication may include Bluetooth, Bluetooth Low Energy, infrared communication (IrDA), UWB, or NFC. The external device may include a control device, another purpose-built vehicle, a relay device, or a user device (e.g., a smartphone, a tablet PC, etc.).

In some embodiments, the controller (210) can transmit data related to the vehicle's driving to the control device (130) via the communication unit (230). Driving-related data may include video data acquired through the vehicle's camera, the vehicle's speed, the steering state, etc.

In some embodiments, the controller (210) can transmit to the control device (130) video data acquired over a predetermined period via the communication unit (230). For example, the controller (210) can transmit data about multiple frames acquired in 30 ms intervals to the control device (130) via the communication unit (230).

In some embodiments, the controller (210) can transmit the video data acquired through the camera to the control device (130) frame by frame via the communication unit (230). For example, the PBV (110) can transmit the acquired frames to the control device (130) each time it obtains them.

In some embodiments, the controller (210) can send video data to the control device (130) via the communication unit (230) in response to identifying a predetermined event. For example, if, based on the vehicle's driving environment (e.g., slope, location, traffic conditions) and user input, it is determined that remote control of the vehicle is necessary, the controller (210) can send the video data to the control device (130) via the communication unit (230).

In some embodiments, the controller (210) can encode the acquired video data. The encoding method may vary depending on the specifications of internal components such as the CPU or GPU of the purpose-built vehicle (110) and may be determined in consideration of the network status.

In some embodiments, by executing at least one command (221) stored in the memory (220), the controller (210) can perform the operations or data processing related to control and/or communication of at least one other component of the purpose-built vehicle (110).

In some embodiments, the controller (210) can include at least one of a CPU, GPU, MCU, sensor hub, supplementary processor, communication processor, application processor, ASIC, or FPGA and can have multiple cores.

In some embodiments, by executing software, for example, the controller (210) can control at least one other component of the PBV (110) (hardware or software) and can perform various data processing or operations.

In some embodiments, as at least part of data processing or operations, the controller (210) may store commands or data received from other components in a volatile memory, process the commands or data stored in the volatile memory, and store the resulting data in a non-volatile memory.

In some embodiments, the controller (210) may include a main controller (for example, a central processing unit or application controller) or, independently or together with it, a supplementary controller (for example, a GPU, NPU, image signal controller, sensor hub controller, or communication controller). For example, if the PBV (110) includes both a main controller and a supplementary controller, the supplementary controller may consume less power than the main controller or be specialized for assigned functions. The supplementary controller may be implemented separately from or as part of the main controller.

In some embodiments, the sensing unit (240) can include a variety of sensors to detect objects adjacent to the PBV (110) and identify the vehicle's state. For example, the PBV (110) may include one or more cameras, LiDAR sensors, IMU sensors, load sensors, proximity sensors, etc.

In some embodiments, the PBV (110) can acquire data regarding its surroundings (images or video) through a camera. The PBV (110) can analyze images of its surroundings acquired by the camera to identify nearby objects (e.g., people, other vehicles, work modules, trailers, etc.) and can generate information about the work environment based on the identified object information. For example, the PBV (110) can transmit a driving image of the vehicle acquired via its camera to the control device, which can analyze it and send a signal for remote control of the PBV (110). The driving image can include not only 2D images but also images (pixel-level data points) collected by a 3D image sensor. For example, the driving image can include not only RGB, RGBA but also xyzRGB, normal, or curvature-based images.

In some embodiments, through a proximity sensor, the PBV (110) can identify objects close to the vehicle (110). For example, the PBV (110) can sense the presence of objects such as other vehicles, pedestrians, animals, or objects located near the PBV (110) via the proximity sensor. For example, the PBV (110) can identify the distance between itself and the surrounding objects via the proximity sensor. This allows the PBV (110) to perform operations such as collision avoidance, lane change, or work. For example, the PBV (110) can identify the speed and direction of surrounding objects via the proximity sensor. For example, the PBV (110) can generate a 3D map of its surroundings based on data obtained from the proximity sensor and other sensors in the sensing unit (240).

In some embodiments, through a LiDAR sensor, the PBV (110) can generate information about its surroundings. For example, the PBV (110) can identify the distance and location between itself, and surrounding objects using the LiDAR sensor and can generate 3D environment map information based on data obtained from other sensors as well. Also, for example, the PBV (110) can identify and classify surrounding objects and track their speed and movement through the LiDAR sensor. Moreover, the PBV (110) can precisely recognize the driving and work environment (e.g., lanes, road boundaries, obstacles, etc.) around the vehicle using the LiDAR sensor.

In some embodiments, the PBV (110) can acquire data on its movement and direction via the IMU sensor. Through the IMU sensor, the PBV (110) can acquire information regarding linear acceleration, angular velocity, and magnetic fields for a work module, including an accelerometer, a gyroscope, or a magnetometer. For example, the PBV (110) can acquire information regarding speed changes (acceleration or deceleration) via the IMU sensor. For example, the PBV (110) can acquire information about angular velocity (changes in direction, rotation, or tilt) via the IMU sensor. The PBV (110) can generate information about its current posture and tilt based on information about acceleration and angular velocity acquired via the IMU sensor. The IMU sensor can be used together with a GPS (not shown).

In some embodiments, the driving unit (250) can include configurations for controlling the movement of the PBV (110) and the work module. Through the driving unit (250), the PBV (110) can control driving, direction adjustments, speed control, and specific actions of the work module.

In some embodiments, the controller (210) can operate one or more camera modules in the purpose-built vehicle, set and support designated shooting modes so that the one or more camera modules perform the user's intended operation. The memory can store applications associated with one or more camera modules. Each camera module may include at least one lens set that includes at least one lens, and at least one image sensor. For example, the PBV (110) can acquire an image corresponding to a subject using an image sensor that converts into an electrical signal the light emitted or reflected from the subject that passes through at least one lens.

In some embodiments, the PBV (110) can include one or more cameras. These one or more cameras may be cameras of the same type having the same specifications (e.g., pixel or field of view) or may be implemented with different specifications. For example, if the PBV (110) has two cameras, it can support functions related to dual cameras (e.g., depth measurement, autofocus).

In some embodiments, additional hardware or sensors that assist in shooting, such as a flash, can be placed in the PBV (110). For example, a distance sensor (e.g., a time-of-flight (TOF) sensor) for detecting the distance between the subject and the PBV (110) may be further included in the area where the camera is located.

In some embodiments, a raw image acquired via the camera module can undergo a processing step in a component of the PBV (110) or a sub-component of the controller (210) so as to convert it into a format that can be processed.

In some embodiments, the process of handling data that makes up the raw image can be performed by an ISP (image signal processor).

In some embodiments, at least part of the process of handling the data that composes the raw image can be performed by an arithmetic unit included in the image sensor.

In some embodiments, the PBV (110) can include one or more IC chips in order to carry out the various functions and operations disclosed in this disclosure. For example, an AP (application processor), a CPU, a GPU, an NPU (neural processing unit), an ISP (image signal processor) installed in a camera module, a DDIC (display driver IC), or a hardware encoder included in the PBV (110) can be used to implement the various embodiments described in this disclosure. In this disclosure, the term “processor” can be understood to include one or more hardware processing circuits.

In some embodiments, the camera included in the PBV (10) can include a lens assembly, an image sensor, a sensor interface, an ISP, a controller, and a flash.

In some embodiments, the optical information of the subject entering through the lens assembly can be converted into electrical signals by the image sensor. The signal output from the image sensor can be input into the ISP (image signal processor) through the sensor interface. An infrared cut filter (IR cut filter) may be placed on top of the image sensor. The light of the subject that passes through the lens is partially filtered by the IR filter and is then detected by the image sensor.

In some embodiments, the ISP can perform operations related to the video signal output from the image sensor. The ISP may include at least one of an ISP chain or a Pre-ISP. The ISP can perform image signal processing to obtain desired image data from the video signal. The Pre-ISP can perform operations related to the video signal before the ISP chain performs image signal processing. For example, auto white balance (AWB), auto exposure (AE) control, and auto focusing (AF) can be performed by the Pre-ISP. The ISP can store data in memory or use data stored in memory in order to perform operations related to the video signal.

In some embodiments, the ISP's ISP chain can handle the video signal acquired through the image sensor. For example, the ISP chain can perform at least one of lens shading correction, dead pixel correction, noise control, tone curve adjustment, edge enhancement, demosaic, or remosaic.

In some embodiments, the ISP can be implemented as at least part of a controller (210) (or integrated circuit). However, it is not limited to this. In some embodiments, the ISP can be implemented as a separate processor (or integrated circuit). In some embodiments, the ISP can be implemented by the arithmetic unit included in the image sensor. In some embodiments, the ISP may be distributed among multiple components (e.g., the arithmetic unit of the image sensor, a separate processor, a controller).

In some embodiments, the controller can control a display to display the execution screen of an application run by the controller or a screen stored in memory. The memory can include at least one recording medium. For example, the memory may include at least one of a volatile memory such as RAM, a nonvolatile memory such as flash memory, or a buffer memory.

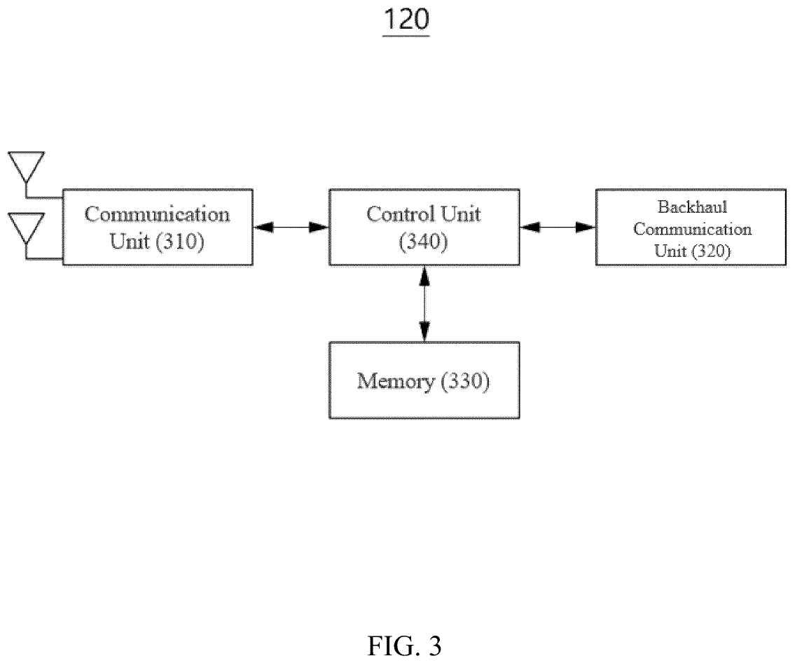

FIG. 3 illustrates the configuration of a base station in a wireless communication system according to various embodiments of the present disclosure. The configuration in FIG. 3 may be understood as the configuration of the base station (120). The terms “ . . . unit” or “ . . . device” used below refer to units that process at least one function or operation, and may be implemented in hardware, software, or a combination of hardware and software.

Referring to FIG. 3, the base station includes a wireless communication unit (310), a backhaul communication unit (320), memory (330), and a controller (340).

In some embodiments, the wireless communication unit (310) can perform functions for transmitting and receiving signals via a wireless channel. For example, according to the physical layer specifications of the system, the wireless communication unit (310) can perform conversion between baseband signals and bitstreams. For example, for data transmission, the wireless communication unit (310) can create complex symbols by encoding and modulating the transmit bitstream. Also, for data reception, the wireless communication unit (310) can restore the received bitstream by demodulating and decoding the baseband signal.

In some embodiments, the wireless communication unit (310) can upconvert a baseband signal into an RF-band signal and transmit it through an antenna and can downconvert an RF-band signal received through the antenna into a baseband signal. For this, the wireless communication unit (310) can include a transmit filter, a receive filter, an amplifier, a mixer, an oscillator, a DAC, an ADC, etc. Also, the wireless communication unit (310) can include multiple transmit/receive paths and can further include at least one antenna array composed of multiple antenna elements.

In some embodiments, in terms of hardware, the wireless communication unit (310) can be composed of a digital unit and an analog unit. The analog unit can consist of multiple sub-units depending on operating power, operating frequency, etc. The digital unit can be implemented by at least one processor (e.g., a DSP).

In some embodiments, as described above, the wireless communication unit (310) transmits and receives signals. Thus, all or part of the wireless communication unit (310) may be referred to as a “transmitter,” “receiver,” or “transceiver.” Also, in the following description, transmitting and receiving via a wireless channel includes the processes described above by the wireless communication unit (310).

In some embodiments, the backhaul communication unit (320) can provide an interface for communication with other nodes in the network. That is, the backhaul communication unit (320) can convert the bitstream transmitted from the base station to another node (e.g., another access node, another base station, an upper node, a core network, or the control device (130)) into a physical signal, and can convert the physical signal received from another node into a bitstream.

In some embodiments, the memory (330) can store data such as basic programs, application programs, setting information, etc., for operating the base station. It can be composed of volatile memory, nonvolatile memory, or a combination of both. The memory (330) can provide stored data in response to a request from the controller (340).

In some embodiments, the controller (340) can control the overall operations of the base station. For example, the controller (340) can transmit and receive signals via the wireless communication unit (310) or the backhaul communication unit (320). Also, the controller (340) can read or write data to the memory (330). Additionally, the controller (340) can perform functions of a protocol stack required by communication standards. In other implementations, the protocol stack may be included in the wireless communication unit (310). To do this, the controller (340) can include at least one processor. Here, the channel estimator, PF scheduler, weight determination unit, SINR estimator, and beamforming vector determination unit can be sets of instructions or code stored in the memory (330), at least temporarily residing in the controller (340), or part of the circuitry that composes the controller (340).

According to one embodiment, the base station (120) can mediate signaling between the purpose-built vehicle (110) and the control device (130). In other words, it can deliver data received from the purpose-built vehicle (110) to the control device (130), and deliver data received from the control device (130) to the purpose-built vehicle (110).

According to various embodiments, the controller (340) can estimate the channel for each terminal based on reference signals received from each purpose-built vehicle (110), and based on the estimated channel information, can determine a matrix representing beamforming vectors for each terminal reflecting scheduling and power allocation information.

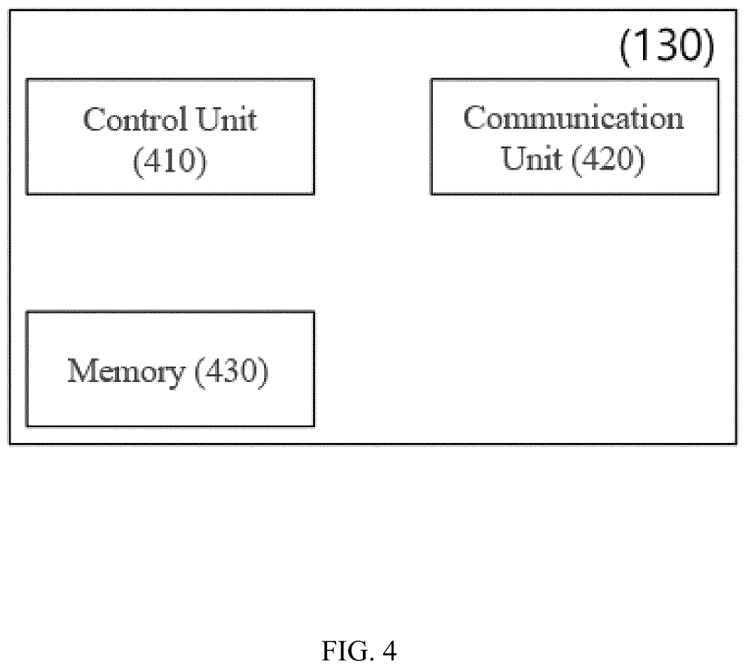

FIG. 4 illustrates a block configuration of a control device according to an embodiment.

According to one embodiment, the control device (130) can include a controller (410), memory (420), a communication unit (430), a display (440), and an input unit (450).

In some embodiments, the memory (420) is a storage medium used by the purpose-built vehicle (110) and can store data such as at least one command (421) or setting information corresponding to at least one program. The program can include an operating system (OS) and various application programs.

In some embodiments, the memory (420) can store data received from an external electronic device (for example, another purpose-built vehicle) located adjacent to the PBV (110). For example, data received from an external electronic device can include information on a work module or information on a work environment.

In some embodiments, the memory (420) can include at least one type of storage medium such as a flash memory, a hard disk, a micro-type multimedia card, a card-type memory (e.g., SD optical disk.

According to one embodiment, the communication unit (430) can provide a wired/wireless communication interface enabling communication with external devices (e.g., other vehicles, a control device, a base station, etc.).

In some embodiments, the communication unit (430) can include at least one of a wired communication unit, a wireless LAN communication unit, or a short-range wireless communication unit. The wireless LAN communication unit can, for example, include Wi-Fi and support IEEE 802.11x standards of the IEEE.

In some embodiments, the control device (130) can be connected by wire to the base station (120).

In some embodiments, under the control of the controller (410), the communication unit (430) can communicate wirelessly with the purpose-built vehicle (110). The communication unit (430) can communicate with the purpose-built vehicle (110) via the base station (120).

In some embodiments, if the purpose-built vehicle (110) is located within a predetermined range of the control device (130), the control device (130) can perform short-range wireless communication with the vehicle (110). Such short-range communication may include Bluetooth, Bluetooth LE, IrDA, UWB, or NFC. The external device can include a purpose-built vehicle, a relay device, or a user device (e.g., a smartphone, a tablet PC).

In some embodiments, the control device (130) can receive various types of data from the purpose-built vehicle (110) via the communication unit (430) (and the base station (120)), such as driving data, information on the work module connected to the purpose-built vehicle (110), or information on the PBV's surroundings.

In some embodiments, the control device (130) can transmit various types of data to the purpose-built vehicle (110) (e.g., information about a work module, information about the driving route of the PBV (110), or an autonomous driving model) via the communication unit (430).

According to one embodiment, by executing at least one command (421) stored in the memory (420), the controller (410) can perform operations or data processing related to control and/or communication of at least one other component of the PBV (110).

In some embodiments, the controller (410) can include at least one of a CPU, GPU, MCU, sensor hub, supplementary processor, communication processor, application processor, ASIC, or FPGA and can have multiple cores.

In some embodiments, by executing software, for example, the controller (410) can control at least one other component (hardware or software) of the PBV (110) connected to it and can perform various data processing or operations.

As part of data processing or operations, the controller (410) can store commands or data received from other components in volatile memory, process commands or data stored in volatile memory, and store the result in nonvolatile memory.

In some embodiments, the controller (410) can include a main controller (e.g., a CPU or application controller) or, independently or together, a supplementary controller (e.g., GPU, NPU, image signal controller, sensor hub controller, or communication controller). For example, if the PBV (110) has a main controller and a supplementary controller, the supplementary controller can use less power than the main controller or be specialized for designated functions. The supplementary controller can be implemented separately from or as part of the main controller.

In some embodiments, the controller (410) can decode the video data received from the purpose-built vehicle (110). The control device (130) can display the decoded video data on the display (440).

According to one embodiment, the display (440) can perform functions for outputting information in the form of numbers, characters, images, or graphics, and can include at least one hardware module for output. The hardware module(s) can include an LCD, LED, LPD, OLED, AMOLED, or FLED. The display (440) can display a screen corresponding to data received from the controller (410). The display (440) may also be referred to by terms such as “output unit,” “display,” or other terms of equivalent technical meaning.

In some embodiments, the control device (130) can display, via the display (440), driving-related information about the purpose-built vehicle (110). For example, the control device (130) can include on the display (440) the driving path, speed, driving environment, information about the work module, and information about the work environment for the PBV (110).

In some embodiments, the purpose-built vehicle (110) can identify user inputs for controlling the control device (130) and the vehicle (110) through an input unit (450). For example, the user input can include user input to adjust the steering of the PBV (110) (e.g., the handle). For example, it can include user input to adjust the vehicle's speed (e.g., the pedal).

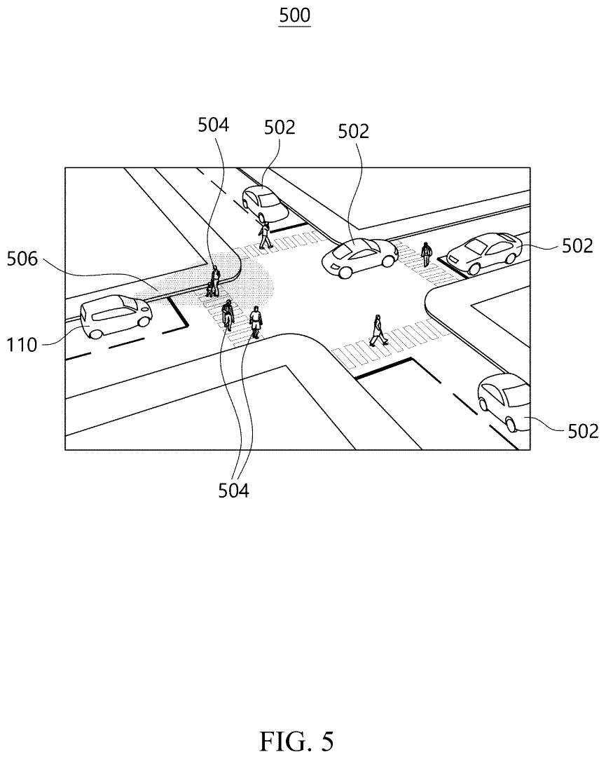

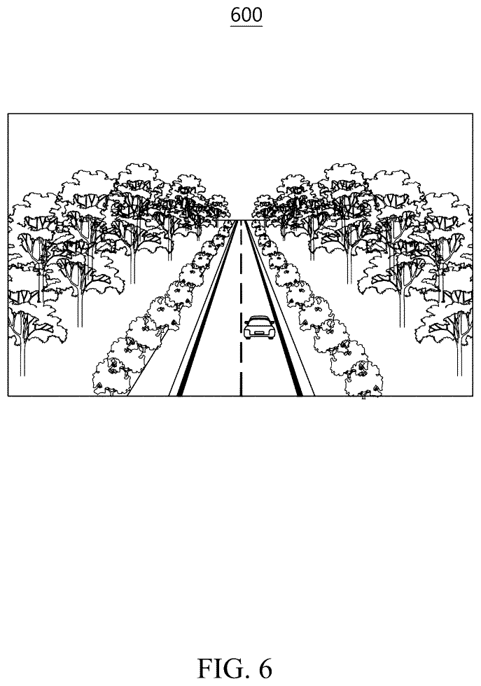

FIG. 5 illustrates an example of the operating environment of a purpose-built vehicle according to one embodiment, and FIG. 6 illustrates another example of the operating environment. The PBVs shown in FIGS. 5 and 6 can include devices corresponding to the PBV (110) of FIGS. 1-4. The operating environment, the objects around the PBV, and the items shown in FIGS. 5 and 6 are merely examples. The same embodiments of this disclosure can be applied to PBVs operating in different environments.

Referring to FIG. 5, the operating environment (500) can be an environment in which the PBV (110) is traveling in an urban area. The environment (500) can include other vehicles (502) and pedestrians (504). Through the camera of the PBV (110), the vehicle can photograph objects located at the front of the PBV (110) with a first angle of view (506). The first angle of view (506) can vary depending on the specifications of the camera of the PBV (110) or camera settings. The PBV (110) can obtain the driving image captured with the first angle of view (506) and transmit it to the control device. The PBV (110) can identify the other vehicle (502) and pedestrian (504) near it as different objects and can identify the distance between them. The environment (500) can include various objects such as pedestrians, other vehicles, lanes, crosswalks, signs, and traffic lights.

Referring to FIG. 6, the operating environment (600) can be a high-speed driving environment for the PBV (110). For example, environment (600) can include a scenario where the PBV (110) is traveling on a freeway. Unlike environment (500), environment (600) might not include pedestrians, etc.

For the PBV (110) to receive a remote-control signal from the control device (130) and perform remote driving, the PBV (110) can transmit the driving image it acquires to the control device. In order to adaptively perform encoding according to the vehicle's conditions, the PBV (110) can partition the image area and carry out different pre-processing by region, thereby efficiently managing the latency for transmitting the driving image.

In some embodiments, the PBV (110) can consider the network status of the vehicle, the resource load rate of the vehicle (e.g., CPU usage, GPU usage, etc.), the vehicle's operating environment, etc., and adaptively carry out region partitioning, pre-processing, and encoding. In the following description, “pre-processing” refers to a series of processes of determining which pixels of a specific region of the driving image (e.g., the entire region or a sub-region) will be transmitted to the control device. This series of processes can include deciding the ratio of pixels to be transmitted in that region. For example, for a certain region including the outermost part, 0% of the data might be selected, while for another region including the central part, 100% might be selected. The PBV can, for the area between the outermost part and the center, increase or decrease the data selection ratio depending on the distance from the center or other conditions.

In some embodiments, the PBV (110) can set different pre-processing methods for the image depending on the vehicle's operating environment, thereby reducing latency in data transmission. For example, in environment (500), the kinds of objects included in the driving image can be diverse, and there might be collisions with other vehicles or pedestrians or situations related to traffic violations. Thus, the PBV (110) may transmit high-quality driving images to the control device. In such cases, when performing pre-processing for sub-regions of the driving image, the PBV might select 100% of the pixel data included in those regions and encode them.

In some embodiments, for environment (600), the number of different kinds of objects included in the driving image is smaller, and there are fewer unpredictable situations compared to environment (500). Thus, the PBV (110) may transmit only some regions of the driving image to the control device, rather than the entire region. The operations of the PBV (110) described below are related to the vehicle's operations for efficient transmission of the driving image.

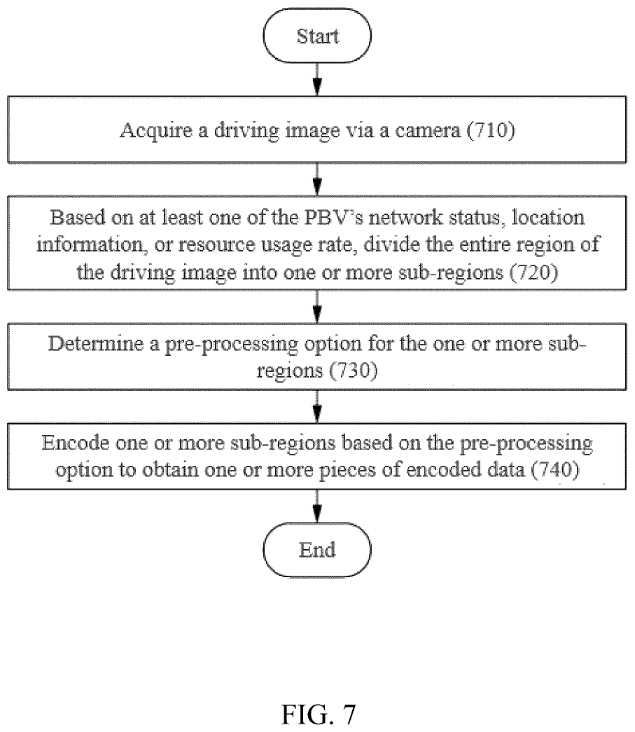

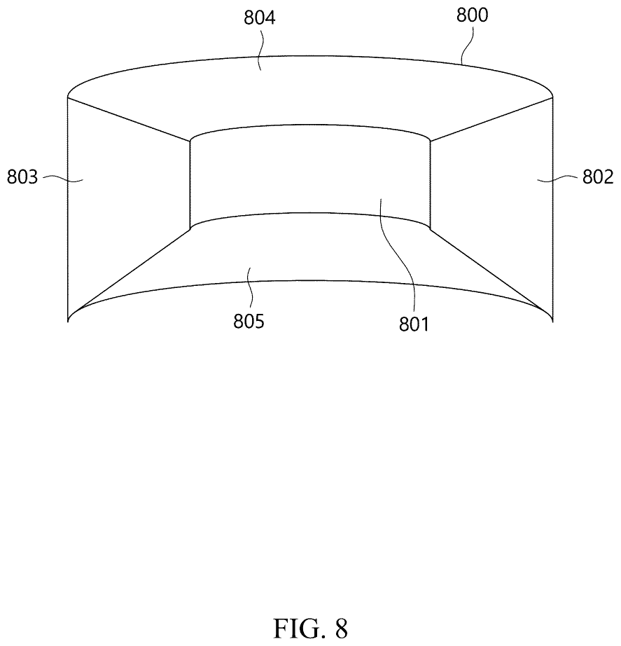

FIG. 7 illustrates a flow of operations for a purpose-built vehicle according to one embodiment. FIG. 8 illustrates an example of partitioning the driving image of a purpose-built vehicle according to one embodiment. The PBV in FIGS. 7 and 8 corresponds to the PBV (110) in FIGS. 1-6.

According to one embodiment, at step (710), the PBV acquires a driving image via a camera. It can use one or more cameras included in the PBV to acquire a driving image of the PBV. The driving image can include an image of the vehicle's operating environment and can include different objects (e.g., pedestrians, other vehicles, lanes, traffic lights) depending on the environment.

According to one embodiment, at step (720), based on at least one of the PBV's network status, location information, or resource usage rate, the PBV can divide the entire region of the driving image into one or more sub-regions.

In some embodiments, the network status refers to how well signals are transmitted between the PBV and the control device or between the PBV and the base station mediating communication, which can be identified via different indicators. For example, it can be identified based on the signal strength (e.g., RSSI) received from the nearby base station. Or, for example, the PBV can identify the network status based on the network latency, i.e., the time it takes for signals to be transferred between the PBV and the control device. Or, for example, the PBV can identify the network status based on the packet loss rate of packets transmitted from the PBV to the control device. If the network is congested or interference is high, the data packet loss rate may increase. For example, the PBV can identify the network status based on the bandwidth usage rate. Because the extent of bandwidth usage indicates the load on the current network, if the bandwidth usage is high (above a reference value), the PBV can judge the network status to be poor. For example, the PBV can identify the network status based on the number of other wireless communication devices (e.g., smartphones, vehicles capable of communication) located near it.

In some embodiments, the vehicle's location information includes information about the current driving location of the PBV. For example, it can be identified based on the vehicle's GPS. For example, the PBV can identify its location information based on the interval and angle of satellite signals (GNSS). Or, for example, it can be identified based on the strength of a cellular signal received from the base station. In an urban area where accurate location identification via GPS signals may be difficult, the vehicle's location can be estimated based on the strength of cellular signals. For example, the PBV can identify its location information based on terrain and geographic features recognized by the vehicle's camera. Using the terrain, buildings, and road network around the PBV recognized through the camera, the PBV can identify its location information. Algorithms and machine learning models for location estimation may be used for this.

In some embodiments, the vehicle's resource load rate is an indicator of how much work the PBV is currently performing and processing. For example, the PBV can identify its resource load rate based on CPU or GPU usage. CPU or GPU usage can refer to the ratio of currently used resources to the total CPU or GPU resources available. Or, for example, the PBV can identify its resource load rate based on its memory usage. The resource load rate can be identified based on the usage of the system memory (e.g., RAM) of the PBV. Or, for example, the PBV can identify its resource load rate based on the PBV's network usage. The vehicle's resource load rate can be identified based on the amount of data being transmitted through the network interface. Or, for example, the PBV can identify its resource load rate based on its I/O usage or the number of processes and threads. Or, for example, it can identify the resource load rate based on the battery status. The vehicle's resource load rate can be identified based on current power consumption.

In some embodiments, the entire region of the driving image may refer to the entire driving image. A sub-region refers to a partial region of that image. For example, referring to FIG. 8, the image region (800) can refer to the entire region, and the image regions (801, 802, 803, 804, 805) can refer to sub-regions.

In some embodiments, if the network status is at or below a certain value, the PBV can divide the entire region of the acquired driving image into multiple sub-regions. That certain value may be a value determined by user settings or by the control device. For example, if the signal received from a nearby base station is at or below a predetermined value, the PBV can divide the entire region of the driving image into multiple sub-regions. Or, for example, if the network latency measured by the PBV is above a predetermined value, the PBV can divide the entire region of the acquired driving image into multiple sub-regions. Or, for example, if the PBV's packet loss rate is above a predetermined ratio, the PBV can divide the entire region of the driving image into multiple sub-regions. Or, for example, if the network bandwidth usage rate of the PBV is above a predetermined value, the PBV can divide the entire region of the acquired image into multiple sub-regions. Or, for example, if the number of devices located adjacent (e.g., within a predetermined range) to the PBV is above a predetermined number, the PBV can divide the entire region of the acquired image into multiple sub-regions.

In some embodiments, if the network status is at or above a certain value, the PBV can set the entire region of the driving image as a single sub-region. If it is judged that the network status is very good, the risk of latency is relatively low, so the PBV can refrain from partitioning and treat the entire region of the driving image as a single sub-region.

In some embodiments, the PBV can divide the entire region of the driving image into multiple sub-regions based on the PBV's location information. The PBV can identify its location via GPS, intervals and angles of satellite signals, or the strength of cellular signals. For example, if it is identified that the PBV's location is within a first region, the PBV can set the entire region of the image it acquired as one sub-region. In other words, within the first region (for example, an urban area), the PBV may not selectively perform pre-processing by region but rather perform the same pre-processing on the entire region and transmit that to the control device. In an urban area, because there are relatively many objects included in the acquired driving image, from a safety standpoint, it may be desirable to transmit 100% of the pixels in the entire driving image rather than selectively partitioning them. Thus, if the PBV's location is judged to be the first region, it can perform encoding for all the pixels (100%) in the entire image region, regardless of the aforementioned conditions. For example, if it is identified that the PBV's location is within a second region (for example, a highway), the PBV can divide the acquired image into multiple sub-regions and vary the ratio of data selection (i.e., pre-processing) by region.

In some embodiments, if the PBV's resource load rate is above a certain value, the PBV can divide the entire region of the driving image into multiple sub-regions. If the PBV's resource load rate is high, it is necessary to minimize the resources used for pre-processing the driving image and sending it to the control device. To do so, the PBV can divide the entire image region into one or more sub-regions and perform different pre-processing for each region or perform encoding for only some regions. For example, if the CPU usage or GPU usage of the PBV is above a certain value, it can divide the entire region of the driving image into multiple sub-regions. If the memory usage of the PBV is above a certain value, it can divide the entire region into multiple sub-regions. If the network usage of the PBV is above a certain value, it can divide the entire region into multiple sub-regions. If the PBV's I/O usage is above a certain value, or if the number of processes and threads is above a predetermined number, it can divide the entire region into multiple sub-regions.

In some embodiments, if the PBV's resource load rate is below a certain value, the PBV can set the entire region of the driving image as a single sub-region. If the resource load rate is judged not to be large, there is less need to reduce the resources required for pre-processing and transmission, so the PBV can refrain from partitioning and just perform pre-processing on the entire region.

Referring to FIG. 8, the PBV can divide the entire region (800) into five sub-regions (801, 802, 803, 804, 805). The example partition in FIG. 8 is just one example. The PBV can partition the entire image region into a number of sub-regions that is more or fewer than five. Also, the PBV can partition the entire image region into sub-regions of a form different from that shown in FIG. 8.

In some embodiments, the PBV can set a weighting for each of the network status, location information, and resource usage rate, and, based on the set weighting and each of these values, can determine a value (K) that in turn determines how the partitioning is carried out. In other words, in the above explanation, for example, the PBV divides the entire region of the image into one or more sub-regions based on any one of the network status, location information, or resource load rate; but it can also use a single function that considers all three (network status, location, resource load rate) to determine how to partition the entire image region (e.g., treat it as one sub-region, partition it into five sub-regions, partition it into nine sub-regions, or exclude some areas). For example, the PBV's partitioning method can be determined by the following equation:

$$K = f ( ax , by , cz ) \qquad \text{<Equation 1>}$$

where K is a value for determining how the PBV partitions. x is an indicator of the PBV's network status, y is an indicator of the PBV's location information, z is an indicator of the PBV's resource load rate, and a, b, c are weights corresponding to the network status, location information, and resource load rate respectively.

Through combinations of the above-mentioned embodiments regarding network status, resource load rate, and location information, the PBV can determine how to partition the entire region of the acquired driving image.

In some embodiments, if K is greater than a first value and less than a second value, the PBV can decide to partition the entire image region into five areas.

In some embodiments, if K is greater than the second value, the PBV can decide to partition the entire image region into nine areas.

In some embodiments, if K is less than the first value, the PBV can decide to set the entire image region as one sub-region.

In some embodiments, the PBV can decide one or more sub-regions based on the vehicle's steering state (e.g., to what angle the steering is turned) or driving state (e.g., the vehicle's speed, whether it is stopped, accelerating, decelerating, or traveling at constant speed). The PBV can change the shape, size, etc., of one or more sub-regions in consideration of the vehicle's steering state and driving state. In other words, the size or shape of the regions shown in FIG. 8 can vary. For example, if the steering state is straight (0 degrees) and the vehicle is traveling at a constant speed, the PBV may judge that the importance of the area at the outer edge of the image is relatively lower, and that the importance of the central area is higher. Therefore, it can increase the size of the central sub-region (801). For example, if the steering state is turned to the left and the vehicle is accelerating, the PBV may judge that the importance of the left area of the acquired image is higher, so it can enlarge sub-region (803) and reduce sub-region (802). For example, if the steering state is turned to the right and the vehicle is decelerating, the PBV may judge that the importance of the right side of the image is relatively higher, so it can enlarge sub-region (802).

According to one embodiment, at step (730), the PBV determines a pre-processing option for the one or more sub-regions.

In some embodiments, the pre-processing option can include information about the number or ratio of pixels to process in that region, the image resolution, frame rate, bitrate, etc. It can include the number of sub-regions, their shapes, sizes, the spacing between sub-regions, and the ratio of selected data per sub-region (i.e., the percentage of pixels in that area that will be encoded).

The data selection ratio for each region can be a fixed value set in advance, or it can vary (increasing/decreasing proportionally to distance from the center or the outermost part).

In some embodiments, the pre-processing option includes information as to whether or not that region will be encoded. For example, it can be determined to encode region (801) at 100% ratio and not encode regions (802, 803, 804, 805).

In some embodiments, the pre-processing option includes information about the resolution or frame rate of the region. For example, it might be decided that sub-region (801) is encoded at a first resolution, whereas sub-regions (802, 803, 804, 805) are encoded at a second resolution.

In some embodiments, the PBV can identify the battery status of the vehicle, and if the battery status is below a predetermined value, perform encoding only on the region with the largest weight among the one or more sub-regions.

In some embodiments, if the PBV is located in a predetermined area and its speed is identified to be below a threshold speed, the PBV can perform encoding on the entire region of the driving image.

In some embodiments, among the one or more sub-regions, the PBV can set the weight of the sub-region located in the direction of the steering state higher than that of the region corresponding to the opposite direction.

In some embodiments, upon identifying a predetermined type of object in the driving image, the PBV can set the resolution and bitrate of the region containing the object higher than those of the region without the object.

According to one embodiment, at step (740), the PBV can perform pre-processing for one or more sub-regions based on the pre-processing option and perform encoding on it to obtain one or more pieces of encoded data. The one or more pieces of encoded data can be data generated by encoding one or more sub-regions based on the pre-processing option.

In some embodiments, the PBV can transmit image data containing the one or more pieces of encoded data to the control device.

In some embodiments, the image data can include multiple packets generated to transmit the one or more pieces of encoded data to the control device.

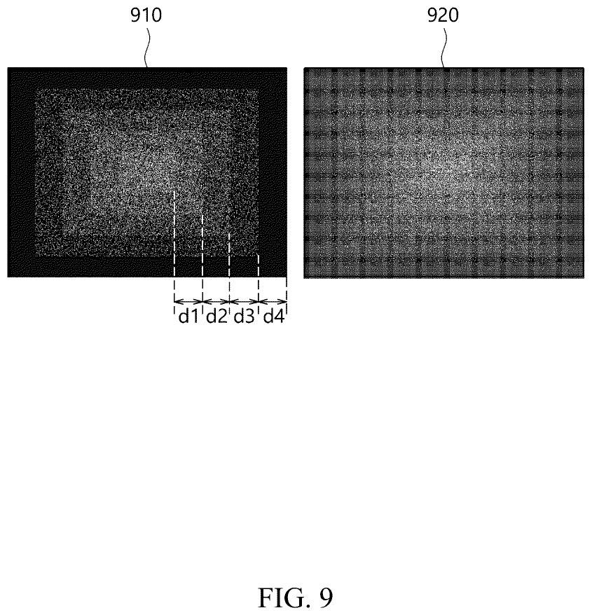

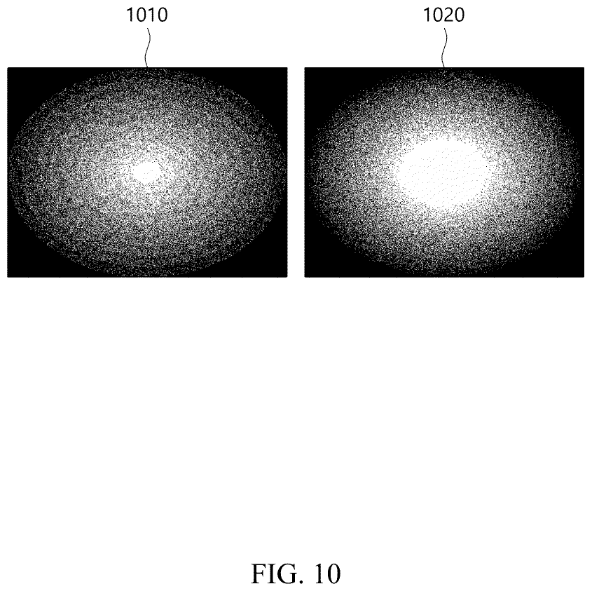

FIG. 9 illustrates an example of per-region pixel selection in a purpose-built vehicle according to one embodiment, and FIG. 10 illustrates another example of per-region pixel selection in a purpose-built vehicle. The drawings and description in FIGS. 9 and 10 can encompass all the content of step (720) and step (730) of FIG. 7.

Referring to FIG. 9, the PBV can partition the entire region of the driving image (910) into multiple rectangular sub-regions at preset intervals (d1, d2, d3, d4) based on the center, and apply different data selection ratios (pre-processing for encoding) by region. The PBV can select data at 0% in the outermost region and increase the data selection ratio as it moves closer to the center. The interval values for d1, d2, d3, d4 can vary depending on the network status, the PBV's location, and resource usage.

Referring to FIG. 9, the PBV can also partition the entire region of the driving image (920) and set the data selection ratio to decrease continuously from the center area toward the outer area.

Referring to FIG. 10, the PBV can partition the entire region of the driving image (1010) into multiple circular (or elliptical) sub-regions at preset intervals (d1, d2, d3, d4) based on the center, and apply different data selection ratios as pre-processing for encoding. The PBV can choose 0% of the data for the outermost area and increase that ratio as it gets closer to the center. The interval values can differ depending on the network status, the PBV's location, and resource usage rate.

Referring to FIG. 10, the PBV can also set the data selection ratio to decrease continuously from the center to the outer edge of the driving image (1020).

In FIGS. 9 and 10, the bright areas indicate selected data to be encoded, and the black areas indicate data not selected for encoding.

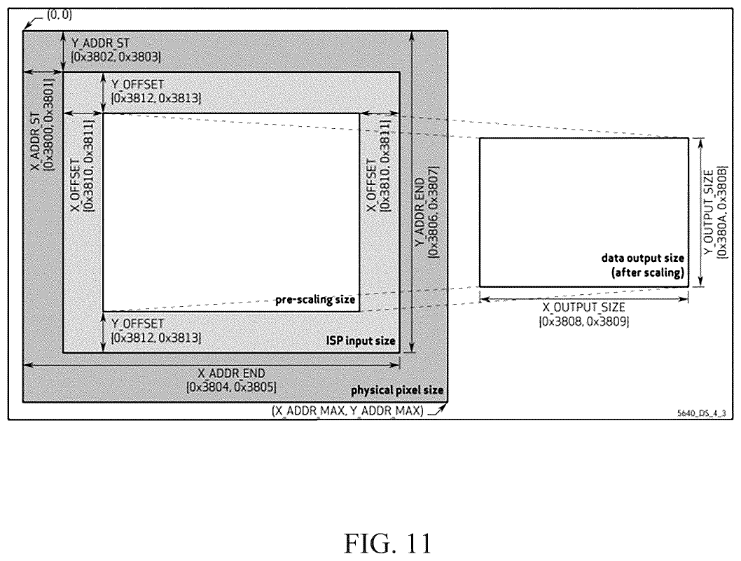

FIG. 11 illustrates an example of image windowing according to one embodiment. The example in FIG. 11 may be a concrete representation of FIG. 9's 910 or 920.

In some embodiments, the PBV can perform image windowing in order to select only some sub-regions (one or more) of the original image (ISP input size) and encode only those regions.

In some embodiments, the PBV can define a specific region of interest (ROI) within the entire original image area (ISP input size). Defining this region can include all the operations of step (720) to identify one or more sub-regions. Then the PBV can extract only the pixel data corresponding to the one or more selected sub-regions from the original driving image and perform encoding based on that extracted data.

In some embodiments, an offset (e.g., X_OFFSET, Y_OFFSET) can indicate the distance from the start point of the original image to the start point of the selected region. The PBV can define this offset variably depending on the network status, resource load rate, location information, etc. Pre-scaling size indicates the size of the selected image region before resizing, and Data output size indicates the size of the output after scaling.

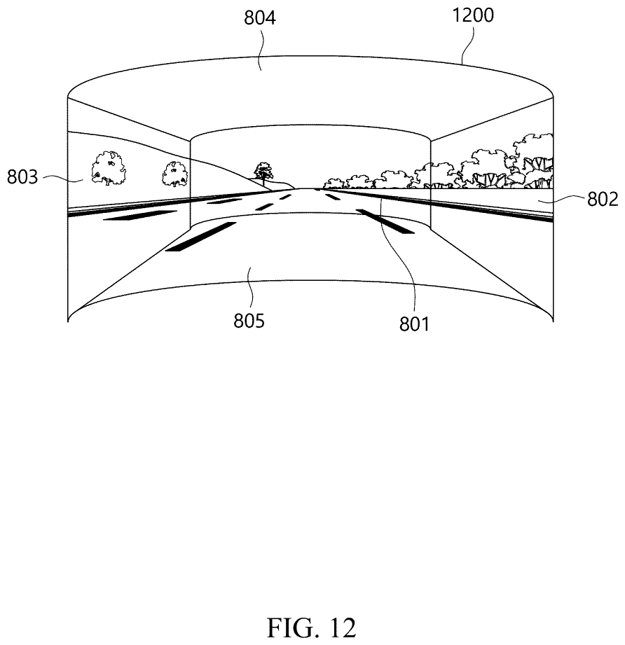

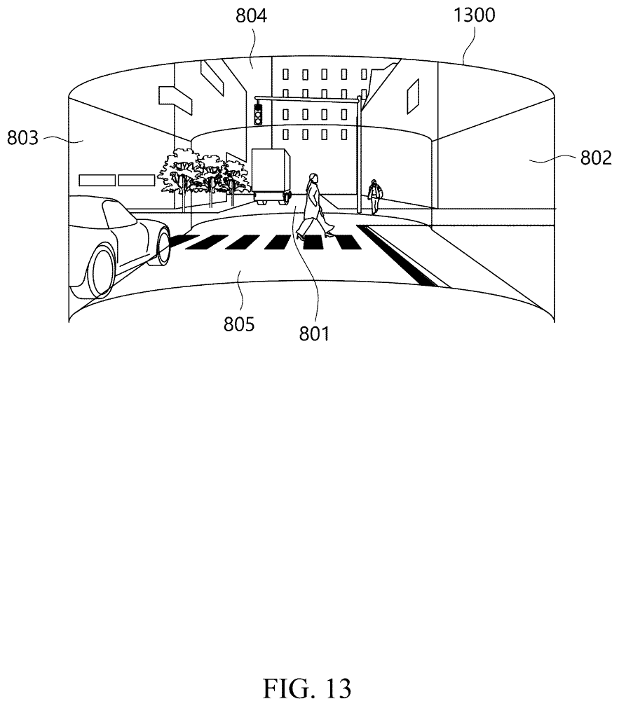

FIG. 12 illustrates an example of partitioning a driving image according to one embodiment. FIG. 13 illustrates another example of partitioning a driving image. FIG. 12 may represent an example of an image acquired when the PBV is traveling at high speed on a highway, while FIG. 13 may represent an example of an image acquired when traveling at low speed in an urban area.

Referring to FIG. 12, the PBV can decide to encode only sub-region (801) out of the entire image region (1200) of the PBV, and not encode the other regions. If, based on the PBV's location, steering state, speed, etc., it is judged that there is no need to transmit data about areas other than the central area to the control device, the PBV can perform encoding only on sub-region (1101) located near the center in order to avoid sending unnecessary data.

Referring to FIG. 13, the PBV can decide to treat the entire image region (1300) of the PBV as a single sub-region, encode the entire image region, and transmit it to the control device. If the driving image contains many objects, and based on network status or location information the PBV is judged to be traveling in an urban area, the PBV may refrain from selective encoding and instead encode the entire image region for transmission to the control device.

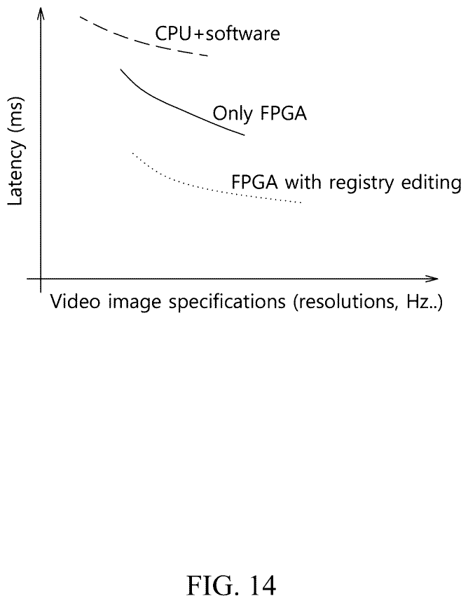

FIG. 14 illustrates an example of latency for per-region encoding according to one embodiment.

Referring to FIG. 14, the graph labeled “FPGA with registry editing” can represent the case of partitioning the entire image region and performing per-region encoding according to the embodiments of this disclosure, and shows that the latency is lower than when using only software or using an FPGA without registry editing.

A purpose-built vehicle device according to an embodiment of the present disclosure includes a driving unit, a camera, a communication unit, and at least one processor connected to the driving unit, the sensor unit, and the communication unit. The at least one processor:
acquires a driving image of the purpose-built vehicle through the camera;
divides the entire region of the driving image into one or more sub-regions based on at least one of the vehicle's network status, location information, or resource usage rate;
determines a pre-processing option for the one or more sub-regions; and
encodes the one or more sub-regions of the driving image based on the pre-processing option to obtain one or more pieces of encoded data, where the pre-processing option can include resolution and bitrate.

In some embodiments, the at least one processor can transmit image data including the one or more pieces of encoded data to the control device via the communication unit.

In some embodiments, the at least one processor can identify the steering state and driving state of the purpose-built vehicle via the driving unit and can identify the one or more sub-regions based on the steering state and the driving state.

In some embodiments, the at least one processor can be configured to determine the weighting of the one or more sub-regions based on the steering state and the driving state and can determine the resolution and bitrate of the sub-regions based on that weighting.

In some embodiments, the at least one processor can be configured to perform encoding for the sub-regions among the one or more sub-regions that have a weight above a threshold.

In some embodiments, the at least one processor can identify the battery status of the purpose-built vehicle, and if the battery status is below a predetermined value, can be configured to perform the encoding only for the region with the largest weight among the one or more sub-regions.

In some embodiments, if the purpose-built vehicle is located in a predetermined area and its speed is identified as below a threshold, the at least one processor can be configured to encode the entire region of the driving image.

In some embodiments, among the one or more sub-regions, the at least one processor can set the weight of the sub-region located in the direction corresponding to the steering state to be higher than that of the region corresponding to the opposite direction of that steering state.

In some embodiments, upon identifying a predetermined type of object in the driving image, the at least one processor can set the resolution and bitrate of the region containing that object higher than those of the region not containing it.

A method of operating a purpose-built vehicle device according to an embodiment of the present disclosure includes:
acquiring a driving image of the purpose-built vehicle through a camera;
dividing the entire region of the driving image into one or more sub-regions based on at least one of the vehicle's network status, location information, or resource usage rate;
determining a pre-processing option for the one or more sub-regions; and.
encoding the one or more sub-regions of the driving image based on the pre-processing option to acquire one or more pieces of encoded data, where the pre-processing option may include resolution and bitrate.

In some embodiments, the operating method of the purpose-built vehicle can further include transmitting image data containing the one or more pieces of encoded data to the control device via the communication unit.

In some embodiments, the operating method of the PBV can include identifying the steering state and driving state of the vehicle (via the driving unit), and identifying the one or more sub-regions based on the steering state and driving state.

In some embodiments, the operating method can include determining the weighting of the one or more sub-regions based on the steering state and driving state, and determining the resolution and bitrate of the sub-regions based on that weighting.

In some embodiments, the operating method can include performing encoding for the sub-regions among the one or more sub-regions that have a weight above a threshold.

In some embodiments, the operating method can include identifying the battery status of the PBV, and if the battery status is below a predetermined value, performing encoding only on the region with the largest weight among the one or more sub-regions.

In some embodiments, the operating method can include, if the PBV is located in a predetermined area and its speed is identified as below a threshold speed, performing encoding on the entire region of the driving image.

Various embodiments of the present disclosure can be applied to many types of devices. For example, an electronic device can include a display device, a portable communication device (e.g., smartphone), a computer, a portable multimedia device, a portable medical device, a camera, a wearable device, or a home appliance. The electronic device according to the embodiments of this disclosure is not limited to the devices described above.

The various embodiments and terms used in this disclosure are not intended to limit the technical features disclosed in this disclosure to certain embodiments, and should be understood to include various modifications, equivalents, or alternatives. For example, unless clearly limited to the singular in context, a component expressed in the singular should be understood to include multiple components. The term “and/or” should be understood to include any and all combinations of one or more of the mentioned items. The terms such as “include,” “have,” “consist of”' are used only to indicate that the relevant features, components, or parts exist in the specification, and are not intended to exclude the possibility of additional features, components, or parts. In this disclosure, expressions such as “A or B,” “at least one of A or B,” “A, B, or C,” “at least one of A, B, or C,” and so on can include any single one of the items or any possible combination of them. Terms such as “first,” “second,” or “primary,” “secondary” may be used only for distinguishing one component from another, not to limit them in terms of importance or sequence.

In the various embodiments of this disclosure, the terms “˜unit” or “˜module” can include hardware, software, or firmware. They can be used interchangeably with terms such as logic, logic block, part, or circuit. A “unit” or “module” can be an integrally configured part, or the smallest unit or part of that part that performs one or more functions. For example, in some embodiments, a “unit” or “module” can be implemented in the form of an ASIC.

In the various embodiments of this disclosure, the expressions “if ˜” can be interpreted as “when ˜,” “upon ˜,” “in response to determining ˜,” or “in response to detecting ˜” depending on context. Similarly, “if it is determined that ˜” or “if it is detected that ˜” can be interpreted in context as “when determined” or “in response to determining,” or “when detected” or “in response to detecting.”

The program executed by the device described in this disclosure can be implemented in hardware components, software components, or a combination of hardware and software. The program can be executed by any system capable of executing computer-readable instructions.

Software can include computer programs, code, instructions, or any combination thereof capable of configuring or directing the processor(s) to operate as desired, either independently or collectively. Software can be implemented as a computer program that includes instructions stored in a computer-readable storage medium. Examples of computer-readable storage media include magnetic storage (e.g., ROM, RAM, floppy disks, hard disks) and optical reading media (e.g., CD-ROM, DVD). Computer-readable storage media can be distributed among network-connected computer systems so that the code is stored and executed in a distributed manner. A computer program can be distributed (e.g., downloaded or uploaded) online via an application store (e.g., Play Store™) or directly between two user devices (e.g., smartphones). In the case of online distribution, at least part of the computer program product can be stored or temporarily created in computer-readable storage media such as a manufacturer's server, an application store's server, or a relay server's memory.

According to various embodiments, each of the abovementioned components (e.g., modules or programs) may include one or multiple entities, and some of those multiple entities may be placed separately from other components. According to various embodiments, one or more of the abovementioned components or operations may be omitted, or one or more other components or operations may be added. Alternatively or additionally, multiple components (e.g., modules or programs) may be integrated into a single component. In that case, the integrated component can perform one or more functions of each of the multiple components in the same or similar manner as before the integration. According to various embodiments, the operations performed by a module, program, or other component can be executed sequentially, in parallel, repeatedly, or heuristically; one or more of those operations can be executed in a different order; omitted; or one or more other operations added.

What is claimed is:

1. A purpose-built vehicle device comprising:
a driving unit;
a camera;
a communication unit;
at least one processor connected to the driving unit, a sensor unit, and the communication unit;
wherein the at least one processor:
acquires, through the camera, a driving image of the purpose-built vehicle;
based on at least one of the vehicle's network status, location information, or resource usage rate, divides the entire region of the driving image into one or more sub-regions;
determines a pre-processing option for the one or more sub-regions; and
encodes the one or more sub-regions of the driving image based on the pre-processing option to obtain one or more pieces of encoded data,
wherein the pre-processing option includes a data selection ratio, resolution, and bitrate.

2. The device of claim 1, wherein the at least one processor is configured to transmit, via the communication unit, image data including the one or more pieces of encoded data to a control device.

3. The device of claim 2, wherein the at least one processor, through the driving unit, identifies a steering state and driving state of the purpose-built vehicle, and is configured to identify the one or more sub-regions based on the steering state and the driving state.

4. The device of claim 3, wherein the at least one processor is configured to determine, based on the steering state and the driving state, a weight for each of the one or more sub-regions, and to determine the resolution and bitrate of the one or more sub-regions based on that weight.

5. The device of claim 3, wherein the at least one processor is configured to perform the encoding for sub-regions among the one or more sub-regions that have a weight above a threshold.

6. The device of claim 4, wherein the at least one processor identifies the battery status of the purpose-built vehicle and, if the battery status is at or below a predetermined value, is configured to perform the encoding only for the region with the highest weight among the one or more sub-regions.

7. The device of claim 3, wherein the at least one processor, if it identifies that the purpose-built vehicle is located in a predetermined area and that its speed is below a threshold, is configured to perform the encoding on the entire region of the driving image.

8. The device of claim 4, wherein among the one or more sub-regions, the at least one processor is configured to set the weight of the sub-region located in the direction corresponding to the steering state higher than that of the region corresponding to the opposite direction of the steering state.

9. The device of claim 1, wherein the at least one processor, upon identifying a predetermined type of object in the driving image, is configured to set the resolution and bitrate of the region containing that object higher than those of the region not containing that object.

10. A method of operating a purpose-built vehicle device, comprising:
acquiring, via a camera, a driving image of the purpose-built vehicle;
dividing, based on at least one of the vehicle's network status, location information, or resource usage rate, the entire region of the driving image into one or more sub-regions;
determining a pre-processing option for the one or more sub-regions; and
encoding the one or more sub-regions of the driving image based on the pre-processing option to obtain one or more pieces of encoded data,
wherein the pre-processing option includes a data selection ratio, resolution, and bitrate.

11. The method of claim 10, further comprising transmitting, via the communication unit, image data including the one or more pieces of encoded data to a control device.

12. The method of claim 11, comprising:
identifying a steering state and driving state of the purpose-built vehicle; and
identifying the one or more sub-regions based on the steering state and the driving state.

13. The method of claim 12, comprising:
determining a weight for each of the one or more sub-regions based on the steering state and driving state; and
determining the resolution and bitrate of the one or more sub-regions based on that weight.

14. The method of claim 12, comprising performing the encoding for sub-regions among the one or more sub-regions that have a weight above a threshold.

15. The method of claim 13, comprising:
identifying the battery status of the purpose-built vehicle; and
if the battery status is at or below a predetermined value, performing the encoding only for the region with the largest weight among the one or more sub-regions.

16. The method of claim 12, comprising:
if it is identified that the purpose-built vehicle is located in a predetermined area and that its speed is below a threshold speed, performing the encoding on the entire region of the driving image.

17. A purpose-built vehicle device comprising:
a driving unit;
a camera;
a communication unit;
at least one processor connected to the driving unit, a sensor unit, and the communication unit,
wherein the at least one processor:
acquires, through the camera, a driving image of the purpose-built vehicle;
based on at least one of the vehicle's network status, location information, or resource usage rate, divides the entire region of the driving image into one or more sub-regions;
determines a pre-processing option for the one or more sub-regions; and
encodes the one or more sub-regions of the driving image based on the pre-processing option to obtain one or more pieces of encoded data,
wherein the pre-processing option includes a data selection ratio, resolution, and bitrate,
and wherein the at least one processor is configured to perform image windowing in order to select only some sub-regions (one or more) of the original image (ISP input size) and encode only those regions.

18. The device of claim 17, wherein the at least one processor is configured to define a specific region of interest (ROI) within the entire original image region (ISP input size), extract only the pixel data corresponding to the selected one or more sub-regions from the original driving image, and encode the extracted data.

19. The device of claim 18, wherein an offset (X_OFFSET, Y_OFFSET) is defined as the distance from the start point of the original image to the start point of the selected region, and the offset is set variably in consideration of the network status, resource load rate, or location information.

20. The device of claim 19, wherein a pre-scaling size indicates the size of the selected image region before resizing, and a data output size indicates the size of the output after scaling.
